(19) United States
(12) Patent Application Publication
(10) Pub. No.: US 2003/0123096 A1
(43) Pub. Date: Jul. 3, 2003

(54) Developing device

(75) Inventors: Takahiro Nakase, Ibaraki (JP); Ryuji Kawano, Ibaraki (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/320,393

(22) Filed: Dec. 17, 2002

(30) Foreign Application Priority Data
Dec. 27, 2001 (JP) 2001-398375

(51) Int. Cl. H04N 1/23; H04N 1/29

(52) U.S. Cl. 358/300

(57) ABSTRACT

A developing device in which, by switching the direction of rotation of a magnet roller disposed near developer receiving openings of respective first and second containers, a developer is selectively supplied to either the first container or the second container. This makes it possible to reduce the developing device and to stably supply the developer to the first and second containers.

### BACKGROUND OF THE INVENTION

1. Field of the Invention

The present invention relates to a developing device for developing an electrostatic image on an image bearing member using a first developer bearing member and a second developer bearing member. The present invention also relates to a developing device used in, for example, a facsimile machine, a printer, or a copying machine of, for example, an electrophotographic type or an electrostatic recording type.

2. Description of the Related Art

In recent years, image forming apparatuses, such as copying machines and printers, are required to output print images at a higher speed.

Therefore, a developing device of a related image forming apparatus has a problem in that, when a developer supplied from a developer container is held on the surface of one developing roller and is electrostatically flown onto (adhered to) an electrostatic latent image on a photosensitive drum to develop (make visible) the electrostatic latent image, the developer held on the surface of the developing roller that is rotated rapidly due to the higher output speed is deteriorated faster.

In addition, the higher output speed reduces the time for developing the electrostatic latent image when it is developed by causing the developer held on the developing roller to fly onto the photosensitive, thereby resulting in the problem of reduced image quality.

To overcome such problems described above, a developing device which makes it possible to restrict a reduction in image quality or deterioration of the developer even in a higher-speed image forming apparatus by developing an electrostatic latent image by using a plurality of developing rollers has been proposed.

For example, there is a developing device 101 shown in FIG. 10 comprising two developing rollers 103a and 103b at an opening of a developer container 102, containing a developer t, that opposes a photosensitive drum 100. The surfaces of the developing rollers 103a and 103b are coated with a thin-film developer by regulating blades 104a and 104b, respectively.

In the developing device 101, a developer t is supplied to the developer container 102 from a developer supplying section 106 through a developer conveyer 107 based on information regarding the amount of developer detected t by a developer amount detecting sensor 105.

There is also a developing device 101 shown in FIG. 11 comprising developer containers 102a and 102b including respective developing rollers 103a and 103b. In the developing device 101, a developer t is supplied to the developer containers 102a and 102b from a developer supplying section 106 through respective developer conveyers 107a and 107b based on information regarding the amounts of developer t detected by respective developer amount detecting sensors 105a and 105b.

In the related developing device 101 shown in FIG. 10, since there is only one developer container 102 and one developer conveyer 107, the related developing device 101 shown in FIG. 10 can be reduced in size, but a difference occurs between the amount of developer t supplied to the developing roller 103a and that supplied to the developing roller 103b when the amount of developer t inside the developer container 102 changes within a range a shown in FIG. 10.

In other words, as shown in FIG. 12, the amount of developer coated on the surface of the developing roller 103a, disposed upstream in the direction of rotation of the photosensitive drum 100, changes depending upon the amount of developer t inside the developer container 102, so that, when the amount of developer t supplied to the developing roller 103a is reduced, the amount of developer coated is reduced, thereby reducing the quality of an output image.

On the other hand, in the related developing device 101 shown in FIG. 11, the amounts of developer t coated on the developing rollers 103a and 103b are consistent because the amounts of developer t supplied to the developer containers 102a and 102b by the respective developer conveyers 107a and 107b are adjusted. However, since space is required to set the two developer conveyers 107a and 107b for supplying the developer t to the respective developer containers 102a and 102b, the related developing device 101 shown in FIG. 10 is increased in size.

### SUMMARY OF THE INVENTION

It is an object of the present invention to provide a developing device which can be reduced in size and which can stably supply a developer to a first developer container and a second developer container. In other words, it is an object of the present invention to provide a developing device which can stably provide a high-quality image.

To this end, according to the present invention, there is provided a developing device comprising a first developer container containing a developer; a first developer bearing member for bearing and conveying the developer inside the first developer container; a second developer container containing a developer; a second developer bearing member for bearing and conveying the developer inside the second developer container. In the developing device, an electrostatic image on an image bearing member is developed by supplying the developer from the first developer bearing member and the second developer bearing member to the electrostatic image. The developing device also comprises single developer conveying means for selectively conveying a supply developer inside a developer supplying container to either the first developer container or the second developer container.

Further objects, features and advantages of the present invention will become apparent from the following description of the preferred embodiments with reference to the attached drawings.

### BRIEF DESCRIPTION OF THE DRAWINGS

FIG. 1 is a schematic structural view of the main portion of an image forming apparatus comprising a developing device of a first embodiment of the present invention.

FIGS. 2A and 2B illustrate conveyance of a developer by a magnet roller of the developing device of the first embodiment of the present invention.

FIG. 3 is a flow chart illustrating the steps for controlling the conveyance of the developer in the first embodiment of the present invention.

FIG. 4 is a flow chart illustrating the steps for controlling conveyance of a developer in a second embodiment of the present invention.

FIG. 5 is a schematic structural view of the main portion of an image forming apparatus comprising a developing device of a third embodiment of the present invention.

FIG. 6 is a flow chart illustrating the steps for controlling conveyance of a developer in the third embodiment of the present invention.

FIG. 7 is a flow chart illustrating the steps for controlling conveyance of a developer in a fourth embodiment of the present invention.

FIG. 8 is a flow chart illustrating the steps for controlling conveyance of a developer in a fifth embodiment of the present invention.

FIG. 9 is a flow chart illustrating the steps for controlling conveyance of a developer in a sixth embodiment of the present invention.

FIG. 10 is a schematic structural view showing an example of a related developing device.

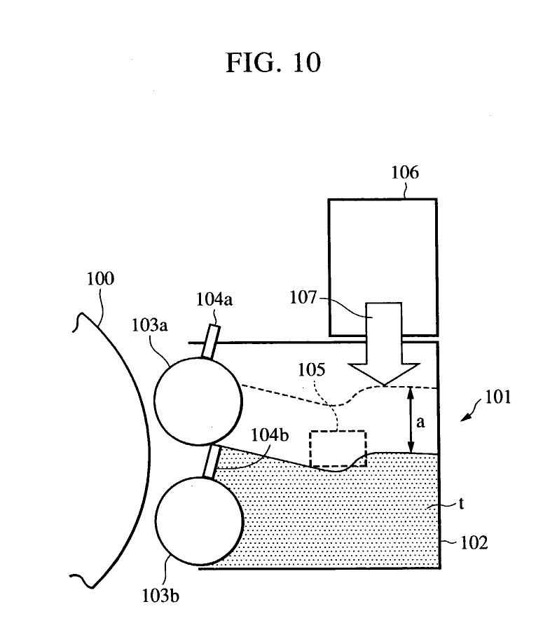

FIG. 11 is a schematic structural view showing another example of a related developing device.

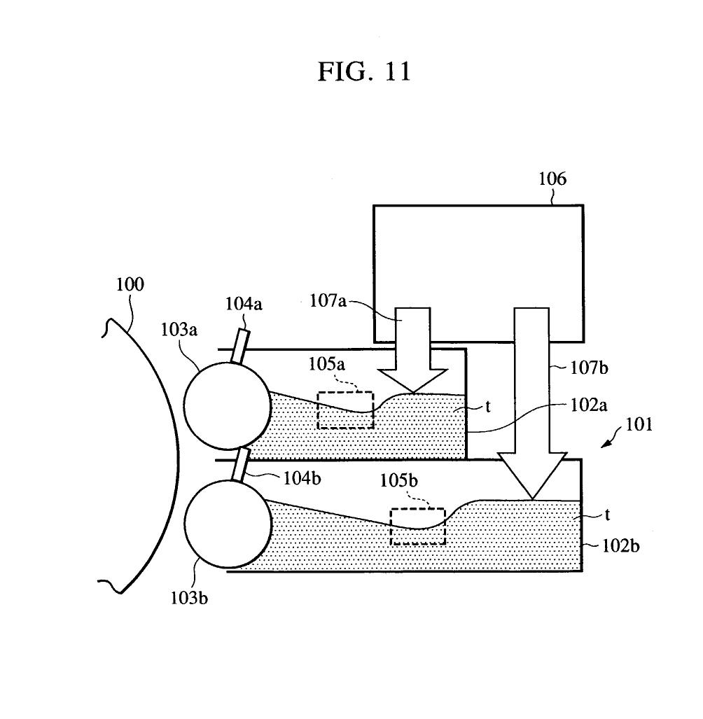

FIG. 12 is a graph showing the relationship between the amount of developer coated on a developing roller and the amount of developer inside a developer container.

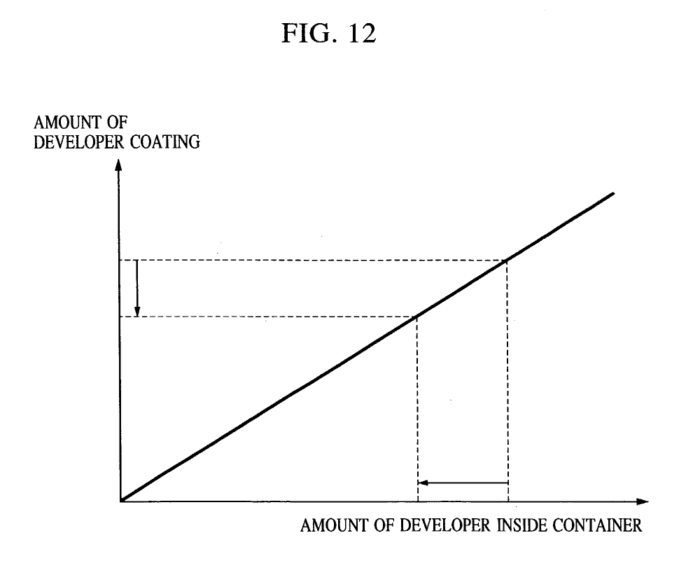

### DESCRIPTION OF THE PREFERRED EMBODIMENTS

Hereunder, a description of the preferred embodiments of the present invention will be given with reference to the drawings.

(First Embodiment)

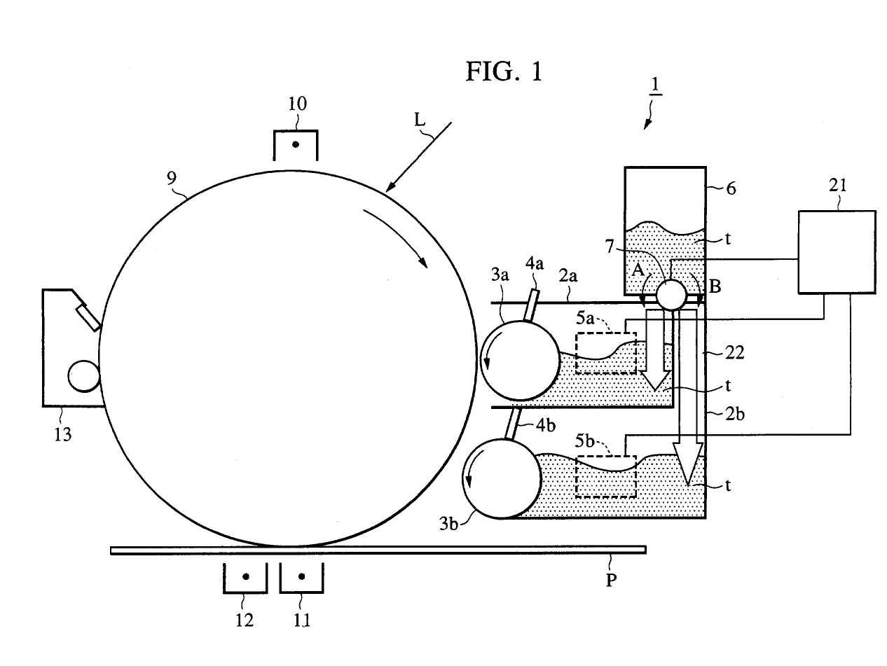

FIG. 1 is a schematic structural view of the main portion of an image forming apparatus comprising a developing device of a first embodiment of the present invention.

In the image forming apparatus, a primary charger 10, a developing device 1, a transfer charger 11, a separation charger 12, and a cleaner 13 are provided around a drum-shaped electrophotographic photosensitive member (hereinafter referred to as “the photosensitive drum”) serving as an image bearing member. When forming an image, the photosensitive drum 9 charged by the primary charger 10 and rotating in the direction of the arrow marked on in FIG. 1 (that is, in the clockwise direction) is exposed to image exposure light L by an exposure device (not shown) in order to form an electrostatic latent image in accordance with input image information. Then, using two developing rollers 3a and 3b of the developing device 1 to which a developing bias, having an AC voltage superimposed upon a DC voltage having the same polarity as the charging polarity of the photosensitive drum 1, has been applied at a developing section, a developer (toner) charged to have the same polarity as the charging polarity of the photosensitive drum 1 is adhered to the electrostatic latent image to make it visible, that is, to form a developed image (or a toner image). (The developing device 1 of the embodiment will be described later in more detail.) For example, a magnetic one-component developer may be used as a developer t.

When the toner image on the photosensitive drum 9 reaches a transfer nip section between the photosensitive drum 9 and the transfer charger 11, a transfer material P, such as a sheet, is fed to the transfer nip section. By the transfer charger 11 to which a transfer bias having a polarity opposite to that of the developer t has been applied, the toner image on the photosensitive drum 9 is transferred onto the transfer material P by electrostatic force generated between the photosensitive drum 9 and the transfer charger 11.

By the separation charger 12 to which a separation bias has been applied, the transfer material P with the toner image is separated from the photosensitive drum 9 and transported to a fixer (not shown). Then, the toner image is heated, subjected to pressure, and fixed onto the transfer material P at a fixing nip section between a fixing roller and a pressure roller (not shown), after which the transfer material P with the fixed toner image is discharged out of the image forming apparatus. Toner remaining on the photosensitive drum 9 after the transfer operation is removed and recovered by the cleaner 13.

Next, a description of the structure of the developing device 1 of the embodiment will be given.

The developing device 1 of the embodiment comprises first and second containers 2a and 2b for containing developers t, and a magnet roller 7, which is a rotary member serving as developer conveying means for conveying a developer t inside a developer supplier 6 (developer supplying container) to the first and second containers 2a and 2b. The developing rollers 3a and 3b are disposed at the openings of the respective first and second containers 2a and 2b along the direction of rotation of the photosensitive drum 9. The developing rollers 3a and 3b are developer bearing members that are rotatable in the directions of the arrows (that is, in the counterclockwise direction) and oppose the photosensitive drum 9 at the developing section. The portion of the developing device 1 of the embodiment that contains the developer is divided into the first container 2a and the second container 2b. The developers t are supplied and adhered to a common electrostatic latent image on the photosensitive drum 9 from the two developing rollers 3a and 3b to make the electrostatic latent image visible. In the embodiment, the first and second containers 2a and 2b are integrally provided. In other words, the first and second containers 2a and 2b of the developing device 1 are vertically divided by a common wall.

The first and second containers 2a and 2b include respective regulating blades 4a and 4b for coating the respective rollers 3a and 3b with the developers t and respective developer amount detecting sensors 5a and 5b for detecting the amounts of developer t.

The first container 2a is integrally formed with the second container 2b at the upper portion of the second container 2b. A path 22 for conveying (supplying) the developer t into the second container 2b through the magnet roller 7 from the developer supplier 6 is formed between the upper portion of the second container 2b and the wall surface of the first container 2a at a side opposite to the developing roller 3a.

The magnet roller 7 is provided below the developer supplier 6 in the longitudinal direction of the developing roller 3a and between the upper portion of the first container 2a and the path 22 above the second container 2b. When the magnet roller 7 is rotated in the direction of arrow A (that is, counterclockwise), the developer t inside the developer supplier 6 is supplied into the first container 2a, whereas, when it is rotated in the direction of arrow B (that is, clockwise), the developer t inside the developer supplier 6 is supplied into the second container 2b through the path 22.

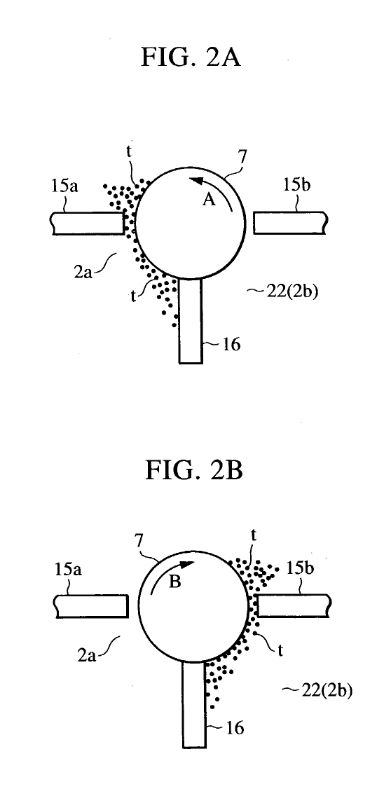

More specifically, as shown in FIG. 2A, when the developer t is to be conveyed into the first container 2a, the developer t inside the developer supplier 6 is attracted to the surface of the magnet roller 7 by the magnetic force of the magnet roller 7. Then, the magnet roller 7 is rotated in the direction of arrow A (that is, counterclockwise), and the amount of developer t borne by the surface of the magnet roller 7 is regulated by a predetermined gap between the magnet roller 7 and a developer regulating plate 15a. By scraping off the regulated amount of developer t borne by the surface of the magnet roller 7 by a developer scraping plate 16 and causing it to fall into the first container 2a, the developer t is conveyed into the first container 2a from the developer supplier 6.

As shown in FIG. 2B, when the developer t is to be conveyed into the second container 2b, the developer t inside the developer supplier 6 is attracted to the surface of the magnet roller 7 by the magnetic force of the magnet roller 7. Then, the magnet roller 7 is rotated in the direction of arrow B (that is, clockwise), and the amount of developer t borne by the surface of the magnet roller 7 is regulated by a predetermined gap between the magnet roller 7 and a developer regulating plate 15b. By scraping off the regulated amount of developer t borne by the surface of the magnet roller 7 by the developer scraping plate 16 and causing it to fall into the second container 2b through the path 22, the developer t is conveyed into the second container 2b from the developer supplier 6.

The conveyance (supply) of the developer t to the first container 2a and the second container 2b from the developer supplier 6 by the rotation of the magnet roller 7 are controlled by a controller 21 based on information regarding detected amounts of developer t input from the respective developer amount detecting sensors 5a and 5b to the controller 21.

Next, a description of the conveyance of the developer t to the first and second containers 2a and 2b of the developing device 1 of the embodiment will be given.

In the case where a developing operation is carried out by the developing device 1, when only the amount of developer t in the first container 2a is detected as being less than a predetermined amount by the developer amount detecting sensor 5a, the controller 21 rotates the magnet roller 7 in the direction of arrow A (that is, counterclockwise) based on the information input to the controller 21 from the developer amount detecting sensor 5a to convey (supply) the developer t into the first container 2a from the developer supplier 6. The developer t inside the first container 2a is supplied to the developing roller 3a by an agitating/conveying member (not shown) and is used to develop the electrostatic latent image on the photosensitive drum 9.

In the case where a developing operation is carried out by the developing device 1, when only the amount of developer t inside the second container 2b is detected as being less than a predetermined amount by the developer amount detecting sensor 5b, the controller 21 rotates the magnet roller 7 in the direction of arrow B (that is, clockwise) based on the information input to the controller 21 from the developer amount detecting sensor 5b to convey (supply) the developer t into the second container 2b from the developer supplier 6 through the path 22. The developer t inside the second container 2b is supplied to the developing roller 3b by an agitating/conveying member (not shown) and is used to develop the electrostatic latent image on the photosensitive drum 9.

In this way, in the embodiment, by conveying and supplying the developer t to the two containers using one common magnet roller 7, that is, by selectively conveying and supplying the developer t by the magnet roller 7, the developing device 1 can be made smaller and less costly.

When, for example, a developing operation consuming a large amount of developer t is carried out, the developer amount detecting sensors 5a and 5b may detect that the amounts of developer t in the respective first container 2a and the second container 2b are less than the predetermined amounts at substantially the same time. In this case, the developer t inside the developer supplier 6 cannot be conveyed to both the first container 2a and the second container 2b at the same time because the magnet roller 7 is formed to selectively convey (supply) the developer t to either the first container 2a or the second container 2b in the direction of rotation of the magnet roller 7.

Therefore, when the developer amount detecting sensors 5a and 5b detect that the amounts of developer t are less than the predetermined amounts at substantially the same time, it is necessary to select either one of the first container 2a and the second container 2b as the container to which the developer t inside the developer supplier 6 is to be conveyed/supplied first. As described above, the developing roller 3b which is positioned at the downstream side in the direction of movement (rotation) of the photosensitive drum 9 (that is, the developing roller which is used to develop the electrostatic latent image later) more greatly affects the sharpness of the toner image, so that, when the downstream-side developing roller 3b does not have enough developer t applied thereto, the desired image quality may not be obtained. This is based on the fact that a high image quality can be obtained when the developer t adhered to the photosensitive member 9 by the upstream-side developing roller 3a is re-disposed onto the electrostatic latent image by the developing operation by the downstream-side developing roller 3b (that is, excess toner on the photosensitive member is scraped off and adhered to a portion of the electrostatic latent image on photosensitive member not having enough toner adhered thereto). In other words, the developing operation by the downstream-side developing roller 3b is important from the viewpoint of providing higher image quality.

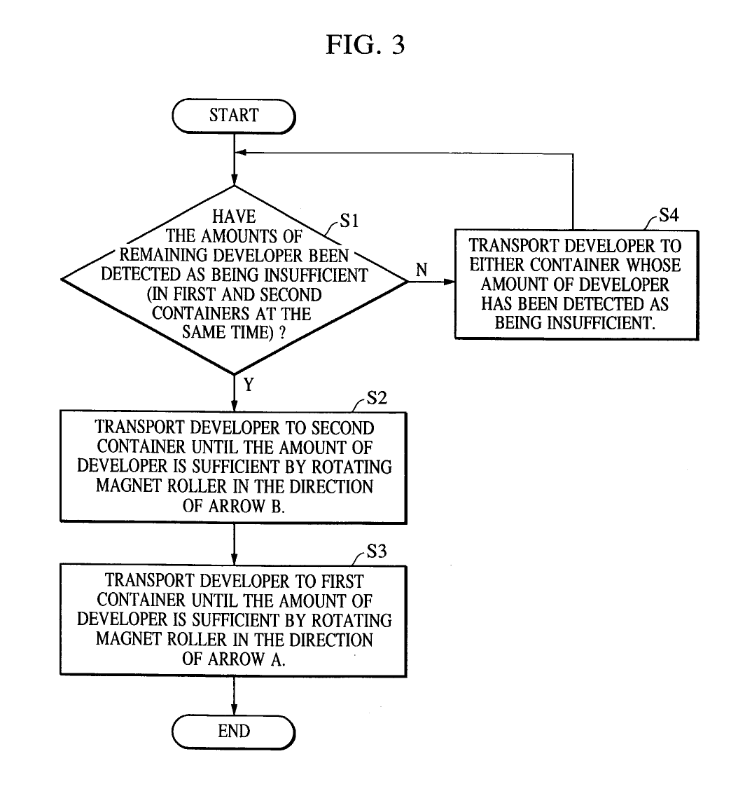

Considering what has been discussed above, the steps for controlling the conveyance of the developer t when the developer amount detecting sensors 5a and 5b have detected that the amounts of developer t are less than the predetermined amounts at substantially the same time will be described with reference to the flowchart of FIG. 3.

First, in the case where, for example, a developing operation consuming a large amount of developer t is carried out, when the developer amount detecting sensors 5a and 5b detect that the amounts of developer t in the respective first and second containers 2a and 2b are less than the predetermined amounts at substantially the same time in Step S1, the magnet roller 7 is rotated in the direction of arrow B by a controlling operation of the controller 21 in order to convey the developer t to the second container 2b not containing enough developer t until the amount of developer t inside the second container 2b is sufficient in Step S2.

Then, when a sufficient amount of developer t has been supplied to the second container 2b and the developer amount detecting sensor 5b detects that the amount of developer t inside the second container 2b is greater than the predetermined amount, the magnet roller 7 is rotated this time in the direction of arrow A by the controlling operation by the controller 21 in order to convey the developer t to the first container 2a not containing enough developer t until the amount of developer t inside the first container 2a is sufficient in Step S3.

When the amount of developer t inside either the first container 2a or the second container 2b is detected as being less than the predetermined amount in Step S1, the direction of rotation of the magnet roller 7 is selected by the controlling operation of the controller 21 in order to convey the developer t inside the developer supplier 6 to either the first container 2a or the second container 2b not containing enough developer t until the amount of developer t inside the container not containing enough developer t is sufficient in Step S4.

In this way, in the embodiment, since the developing device 1 is formed so that the developer t is conveyed/supplied to two developer containers 2a and 2b by one magnet roller 7, that is, since there is only one developer supplying section, the developer t can be stably supplied to the developing rollers 3a and 3b and the developing device 1 can be reduced in size.

In the case where, for example, a developing operation consuming a large amount of developer t is carried out, when the developer amount detecting sensors 5a and 5b have detected that the amounts of developer t inside the respective first container 2a and the second container 2b are less than the predetermined amounts, first, the magnet roller 7 is rotated in the direction of arrow B in order to convey the developer t into the second container 2b. Then, it is rotated in the direction of arrow A in order to convey the developer t into the first container 2a. Therefore, this reduces the shortage of the developer t on the developing roller 3b that greatly affects, for example, the sharpness of the toner image, thereby preventing an improper developing operation. Consequently, a sharp, high-quality image can be obtained.

(Second Embodiment)

A second embodiment of the developing device will be described using the image forming apparatus including the developing device of the first embodiment shown in FIG. 1. The image forming apparatus including the developing device of the second embodiment has a structure similar to the image forming apparatus including the developing device of the first embodiment. Therefore, descriptions of the same features will not be given below. The second embodiment is the same as the first embodiment except in the operation for controlling conveyance of the developer t by the developing device when the developer amount detecting sensors 5a and 5b have detected that the amounts of developer t are less than predetermined amounts at substantially the same time. Therefore, the operation for conveying the developer t in the above-described case in the second embodiment will only be described.

In the second embodiment, when the developer amount detecting sensors 5a and 5b have detected that the amounts of developer t in the respective first container 2a and the second container 2b are less than the predetermined amounts at substantially the same time, the direction of rotation of the magnet roller 7, serving as a developer conveying member, is consecutively varied in order to alternately convey the developer t to the first container 2a and the second container 2b. Here, by making the time for conveying the developer t to the second container 2b longer than the time for conveying the developer t to the first container 2a, the developer t is conveyed to the second container 2b first.

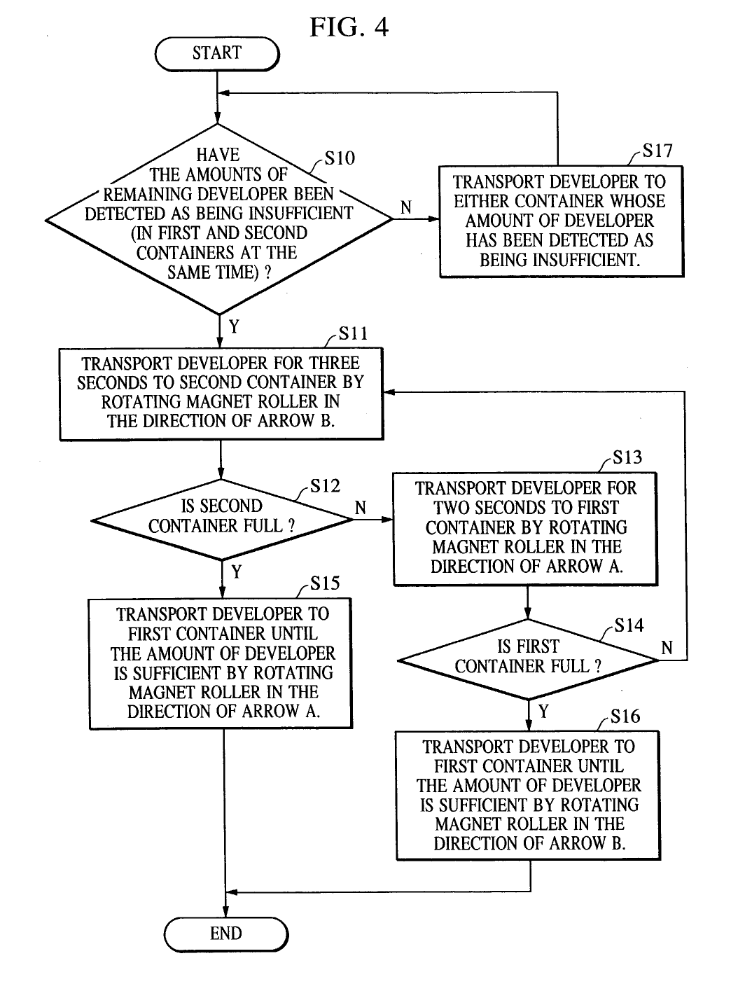

Hereunder, the steps for controlling the conveyance of the developer t when the developer amount detecting sensors 5a and 5b have detected that the amounts of developer t are less than the predetermined amounts at substantially the same time will be described with reference to the flowchart of FIG. 4.

In the case where, for example, a developing operation consuming a large amount of developer t is carried out, when the developer amount detecting sensors 5a and 5b detect that the amounts of developer t in the respective first and second containers 2a and 2b are less than the predetermined amounts at substantially the same time in Step S10, the magnet roller 7 is rotated in the direction of arrow B by a controlling operation of the controller 21 in order to convey the developer t to the second container 2b not containing enough developer t for three seconds in Step S11.

When the developer amount detecting sensor 5a has detected that the second container 2a is not sufficiently filled with the developer t (that is, the amount of developer t is less than the predetermined amount) in Step S12 after conveying the developer t for three seconds in Step S11, the magnet roller 7 is rotated this time in the direction of arrow A by the controlling operation of the controller 21 in order to convey the developer t to the first container 2a not having enough developer t for two seconds in Step S13.

Then, when the developer amount detecting sensor 5a has detected that the first container 2a is not sufficiently filled with the developer t (that is, the amount of developer t is less than the predetermined amount) in Step S14 after conveying the developer t for two seconds in Step S13, the magnet roller 7 is rotated this time in the direction of arrow B by the controlling operation of the controller 21 in order to convey the developer t to the second container 2b not having enough developer t for three seconds in Step S11. In this way, in the developer supplying sequence, the ratio between the time for conveying the developer t to the first container 2a and the time for conveying the developer t to the second container 2b by the rotation of the magnet roller 7 in alternate directions is two to three, so that a larger amount of developer t is conveyed to the second container 2b than to the first container 2a.

While the sequence of steps from Steps S11 to S14 is being repeated, when the developer amount detecting sensor 5b detects that the second container 2b has been filled with the developer t (that is, the amount of developer t is greater than the predetermined amount) in Step S12, the magnet roller 7 is rotated this time in the direction of arrow A by the controlling operation of the controller 21 in order to convey the developer t to the first container 2a not containing enough developer t until it is sufficiently filled with the developer t in Step S15.

While the sequence of steps from Steps S11 to S14 is being repeated, when the developer amount detecting sensor 5a detects that the first container 2a has been sufficiently filled with the developer t (the amount of developer t is greater than the predetermined amount) in Step S14, the magnet roller 7 is rotated this time in the direction of arrow B by the controlling operation of the controller 21 in order to convey the developer t to the second container 2b not containing enough developer t until it is sufficiently filled with the developer t in Step S16.

When the amount of developer t inside either the first container 2a or the second container 2b is detected as being less than the predetermined amount in Step S10, as in the first embodiment, the direction of rotation of the magnet roller 7 is selected by a controlling operation of the controller 21 in order to convey the developer t inside the developer supplier 6 to either the first container 2a or the second container 2b not containing enough developer t until the amount of developer t inside the container not containing enough developer t is sufficient in Step S17.

Accordingly, in the embodiment, in the case where, for example, a developing operation consuming a large amount of developer t is carried out, when the developer amount detecting sensors 5a and 5b detect that the amounts of developer t in the respective first container 2a and the second container 2b are less than the predetermined amounts at substantially the same time, the ratio between the time for conveying the developer t to the first container 2a and the time for conveying the developer t to the second container 2b by the rotation of the magnet roller 7 in alternate directions is two to three. By conveying a larger amount of developer t to the second container 2b than to the first container 2a, the shortage of the developer t on the developing roller 3b that greatly affects, for example, the sharpness of the toner image is reduced, thereby preventing an improper developing operation. Therefore, a sharp, high-quality image can be obtained.

Although, in this embodiment, although the developer t is conveyed to the second container 2b for three seconds and the developer t is conveyed to the first container 2a for two seconds, the developers t may be conveyed for any lengths of time as long as the times for conveying the developers t are adjusted so that a larger amount of developer t is conveyed to the second container 2b than to the first container 2a.

(Third Embodiment)

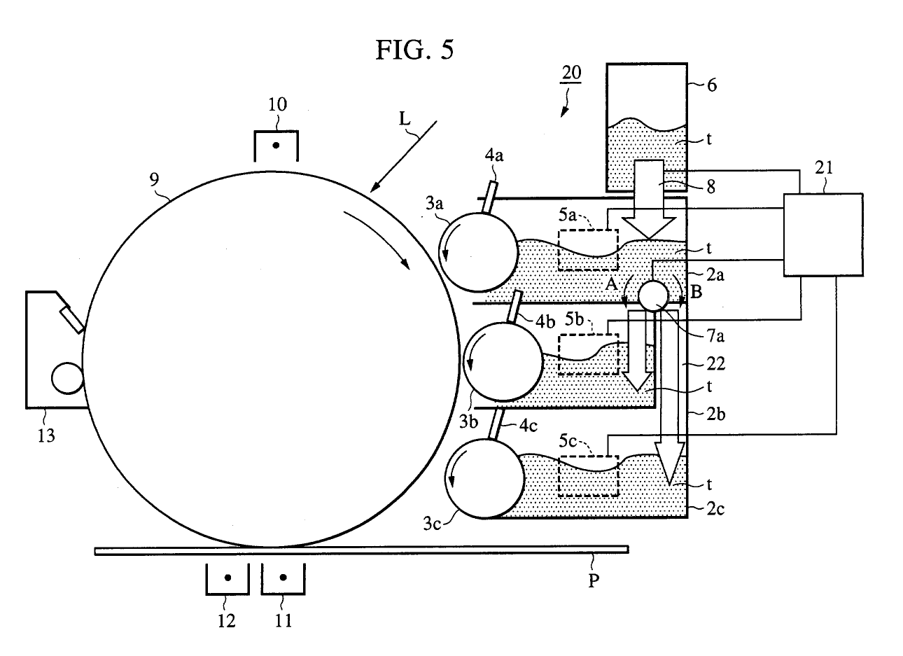

FIG. 5 is a schematic structural view of the main portion of an image forming apparatus including a developing device of a third embodiment of the present invention. Component parts having the same functions are given the same reference numerals. The structural features other than those of the developing device are the same as those given in the first embodiment, so that a description of only the developing device will be given.

As shown in FIG. 5, a developing device 20 of the third embodiment comprises a first container 2a, a second container 2b, and a third container 2c, which contain developers t, and a developer supplier 6 for conveying (supplying) the developer t therein to the first container 2a through a developer conveyer 8. Developing rollers 3a, 3b, and 3c, which serve as developer bearing members and which are rotatable in the direction of the arrows (that is, counterclockwise), are disposed at the openings of the respective first, second, and third containers 2a, 2b, and 2c so as to oppose the photosensitive drum 9 at the developing section. The developer container section of the developing device 20 of the third embodiment is divided into three parts, the first, second, and third containers 2a, 2b, and 2c.

The first, second, and third containers 2a, 2b, and 2c include respective regulating blades 4a, 4b, and 4c for coating the respective rollers 3a, 3b, and 3c with the developers t, and respective developer amount detecting sensors 5a, 5b, and 5c for detecting the amounts of developer t.

The first, second, and third containers 2a, 2b, and 2c are integrally formed in the vertical direction. A path 22 for conveying (supplying) the developer t into the third container 2c through a magnet roller 7a, which is a rotary member serving as means for conveying the developer t, from the first container 2a is formed between the upper portion of the third container 2c and the wall surface of the second container 2b at a side opposite to the developing roller 3b.

The magnet roller 7a is provided below the first container 2a in the longitudinal direction of the developing roller 3a and between the upper portion of the second container 2b and the path 22 above the third container 2c. When the magnet roller 7a is rotated in the direction of arrow A (that is, counterclockwise), the developer t is supplied into the second container 2b, whereas, when it is rotated in the direction of arrow B (that is, clockwise), the developer t is supplied into the third container 2 through the path 22.

By a controlling operation of the controller 21 based on information regarding detected amounts of developer t input from the developer amount detecting sensors 5a, 5b, and 5c, the developer t is conveyed to the first container 2a from the developer supplier 6 by the developer conveyer 8, and the developer t is conveyed to the second container 2b and the third container 2c from the first container 2a by the rotation of the magnet roller 7a.

Hereunder, a description of the conveyance of the developer t to the first, second, and third containers 2a, 2b, and 2c of the developing device 20 of the third embodiment will be given.

In the case where a developing operation by the developing device 20 is carried out, when only the amount of developer t in the upper first container 2a is detected as being less than a predetermined amount by the developer amount detecting sensor 5a, the developer conveyer 8 is operated based on the information input to the controller 21 from the developer amount detecting sensor 5a in order to convey (supply) the developer t into the first container 2a from the developer supplier 6. The developer t inside the first container 2a is supplied to the developing roller 3a by an agitating/conveying member (not shown) and is used to develop an electrostatic latent image on the photosensitive drum 9.

In the case where a developing operation by the developing device 20 is carried out, when only the amount of developer t in the middle second container 2b is detected as being less than a predetermined amount by the developer amount detecting sensor 5b, the controller 21 rotates the magnet roller 7a in the direction of arrow A (that is, counterclockwise) based on the information input to the controller 21 from the developer amount detecting sensor 5b to convey (supply) the developer t into the second container 2b from the first container 2a. The developer t inside the second container 2b is supplied to the developing roller 3b by an agitating/conveying member (not shown) and is used to develop the electrostatic latent image on the photosensitive drum 9.

In the case where a developing operation by the developing device 20 is carried out, when only the amount of developer t in the lower third container 2c is detected as being less than a predetermined amount, the controller 21 rotates the magnet roller 7a in the direction of arrow B (that is, clockwise) based on the information input to the controller 21 from the developer amount detecting sensor 5c to convey (supply) the developer t into the third container 2c from the first container 2a through the path 22. The developer t inside the third container 2c is supplied to the developing roller 3c by an agitating/conveying member (not shown) and is used to develop the electrostatic latent image on the photosensitive drum 9.

When, for example, a developing operation consuming a large amount of developer t is carried out, in particular, the developer amount detecting sensors 5b and 5c may detect that the amounts of developer t in the respective second container 2b and the third container 2c are less than the predetermined amounts at substantially the same time. In this case, the developer t cannot be conveyed to the second container 2b and the third container 2c at the same time because the magnet roller 7a is formed to selectively convey (supply) the developer t to either the second container 2b or the third container 2c in the direction of rotation of the magnet roller 7a.

Therefore, when the developer amount detecting sensors 5b and 5c detect that the amounts of developer t are less than the predetermined amounts at substantially the same time, it is necessary to select either the second container 2b or the third container 2c as the container to which the developer t is to be conveyed/supplied first. As described above, the developing roller 3c that is positioned at the most downstream side in the direction of movement (rotation) of the photosensitive drum 9 more greatly affects the sharpness of the toner image, so that, when the most-downstream-side developing roller 3c does not have enough developer t applied thereto, the desired image quality may not be obtained.

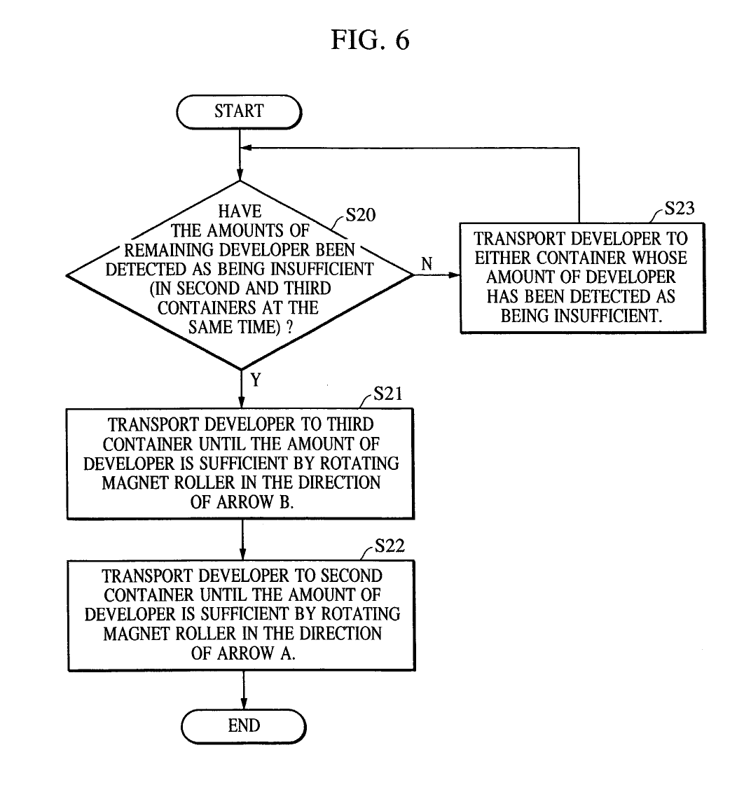

Considering what has been discussed above, the steps for controlling the conveyance of the developer t when the developer amount detecting sensors 5b and 5c have detected that the amounts of developer t are less than the predetermined amounts at substantially the same time will be described with reference to the flowchart of FIG. 6.

First, in the case, for example, a developing operation consuming a large amount of developer t is carried out, when the developer amount detecting sensors 5b and 5c detect that the amounts of developer t in the respective second and third containers 2b and 2c are less than the predetermined amounts at substantially the same time in Step S20, the magnet roller 7a is rotated in the direction of arrow B by the controlling operation of the controller 21 in order to convey the developer t to the third container 2c not containing enough developer t until the amount of developer t inside the third container 2c is sufficient in Step S21.

Then, when a sufficient amount of developer t has been conveyed to the third container 2c and the developer amount detecting sensor 5c detects that the amount of developer t inside the third container 2c is greater than the predetermined amount, the magnet roller 7a is rotated this time in the direction of arrow A by the controlling operation by the controller 21 in order to convey the developer t to the second container 2b not containing enough developer t until the amount of developer t inside the second container 2b is sufficient in Step S22.

When the amount of developer t inside either the second container 2b or the third container 2c is detected as being less than the predetermined amount in Step S20, the direction of rotation of the magnet roller 7a is selected by the controlling operation of the controller 21 in order to convey the developer t to either the second container 2b or the third container 2c not containing enough developer t until the amount of developer t inside the container not containing enough developer t is sufficient in Step S23.

Accordingly, when the developer amount detecting sensors 5b and 5c have detected that the amounts of developer t in the respective second container 2b and the third container 2c are less than the predetermined amounts at substantially the same time, first, the magnet roller 7a is rotated in the direction of arrow B to convey the developer t into the third container 2c. Then, the magnet roller 7a is rotated in the direction of arrow A to convey the developer t into the second container 2b. Therefore, the shortage of the developer t on the developing roller 3c that greatly affects, for example, the sharpness of the toner image is reduced, thereby preventing an improper developing operation. Consequently, a sharp, high-quality image can be obtained.

In the third embodiment, when the developer amount detecting sensors have detected at the same time that the amounts of developer in the respective first container, the second container, and the third container are less than the predetermined amounts, the conveyance of the developer to the first container is controlled in accordance with a signal from the developer amount detecting sensor at the first container regardless of the amounts of developer inside the second and third containers.

The developer is conveyed to the second and third containers so that the developer is conveyed first to the container disposed at the downstream side in the direction of movement or rotation of the photosensitive drum (the third container in the third embodiment).

Although, in the third embodiment, the developer is independently conveyed to the first container, and single conveying means is used to convey ink to the second and third containers, any arrangement may be used in actually conveying the ink.

Accordingly, in the third embodiment, it is possible to stably supply the developer t to the developing rollers 3a, 3b, and 3c from the respective first, second, and third containers 2a, 2b, and 2c and to reduce the size of the developing device.

In the case where, for example, a developing operation consuming a large amount of developer t is carried out, when detections are made that the amounts of developer t in at least two of the first, second, and third containers 2a, 2b, and 2c are not sufficient at the substantially the same time, the developer t is first conveyed to the container not containing enough developer t disposed at the downstream side in the direction of movement or rotation of the photosensitive drum 9. Therefore, the shortage of the developer t on the downstream-side developing roller that greatly affects, for example, the sharpness of the toner image is reduced, thereby preventing an improper developing operation. Consequently, a sharp, high-quality image can be obtained.

(Fourth Embodiment)

A fourth embodiment of the developing device will be described using the image forming apparatus including the developing device of the first embodiment shown in FIG. 1. The image forming apparatus including the developing device of the fourth embodiment has a structure similar to the image forming apparatus including the developing device of the first embodiment. Therefore, descriptions of the same features will not be given below. The fourth embodiment is the same as the first embodiment except in the operation for controlling the conveyance of the developer t by the developing device when the developer amount detecting sensors 5a and 5b have detected that the amounts of developer t are less than predetermined amounts at substantially the same time. Therefore, the operation for conveying the developer t in the above-described case in the fourth embodiment will only be described.

As mentioned above, when the developer amount detecting sensors 5a and 5b have detected that the amounts of developer t are less than the predetermined amounts at substantially the same time, the developer t cannot be conveyed to the first container 2a and to the second container 2b at the same time. Therefore, it is necessary to select either the first container 2a or the second container 2b as the container to which the developer t is to be conveyed first.

As mentioned above, the developing roller 3a, disposed at the upstream side in the direction of movement or rotation of the photosensitive drum 9, that is, the developing roller that is used to develop a common electrostatic image first, most greatly affects the image density. Therefore, when the amount of developer coated on the upstream-side developing roller 3a is insufficient due to an insufficient supply of the developer t to the developing roller 3a, the desired density may not be obtained. The developing rollers have different roles, so that, when the developing device 1 has substantially finished making the electrostatic latent image visible by the developing roller 3a, the developer t on the photosensitive drum is re-disposed onto a portion of the electrostatic latent image not having enough developer t adhered thereto by the downstream-side developing roller 3b as described above. Accordingly, the upstream-side roller 3a has the roles of maintaining and ensuring the image density.

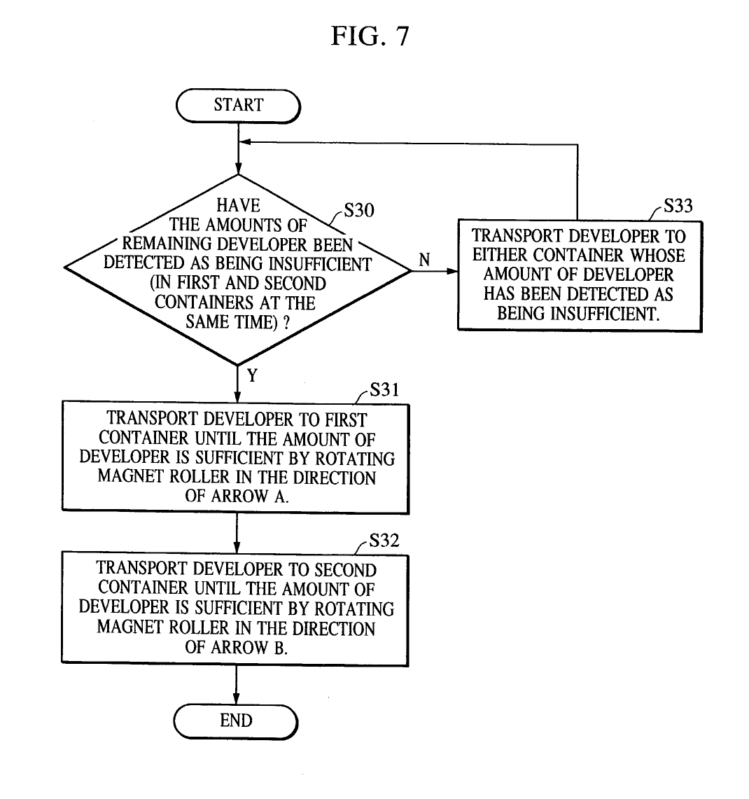

Considering what has been discussed above, the steps for controlling the conveyance of the developer t when the developer amount detecting sensors 5a and 5b have detected that the amounts of developer t are less than the predetermined amounts at substantially the same time will be described with reference to the flow chart of FIG. 7.

First, in the case where, for example, a developing operation consuming a large amount of developer t is carried out, when the developer amount detecting sensors 5a and 5b detect that the amounts of developer t in the respective first and second containers 2a and 2b are less than the predetermined amounts at substantially the same time in Step S30, the magnet roller 7 is rotated in the direction of arrow A by the controlling operation of the controller 21 in order to convey the developer t to the first container 2a not containing enough developer t until the amount of developer t inside the first container 2a is sufficient in Step S31.

Then, when a sufficient amount of developer t has been conveyed to the first container 2a and the developer amount detecting sensor 5a detects that the amount of developer t inside the first container 2a is greater than the predetermined amount, the magnet roller 7 is rotated this time in the direction of arrow B by the controlling operation of the controller 21 in order to convey the developer t to the second container 2b not containing enough developer t until the amount of developer t inside the second container 2b is sufficient in Step S32.

When the amount of developer t inside either the first container 2a or the second container 2b is detected as being less than the predetermined amount in Step S30, the direction of rotation of the magnet roller 7 is selected by the controlling operation of the controller 21 in order to convey the developer t to either the first container 2a or the second container 2b not containing enough developer t until the amount of developer t inside the container not containing enough developer t is sufficient in Step S33.

Accordingly, in the fourth embodiment, in the case where a developing operation consuming a large amount of developer t is carried out, when the developer amount detecting sensors 5a and 5b have detected that the amounts of developer t in the respective first container 2a and the second container 2b are less than the predetermined amounts at substantially the same time, first, the magnet roller 7 is rotated in the direction of arrow A to convey the developer t into the first container 2a. Then, the magnet roller 7 is rotated in the direction of arrow B to convey the developer t into the second container 2b. Therefore, shortage of the developer t on the developing roller 3a that greatly affects the image density is reduced, thereby preventing an image from being formed with improper density. Consequently, a high-quality image can be obtained.

(Fifth Embodiment)

A fifth embodiment of the developing device will be described using the image forming apparatus including the developing device of the first embodiment shown in FIG. 1. The image forming apparatus including the developing device of the fifth embodiment has a structure similar to the image forming apparatus including the developing device of the first embodiment. Therefore, descriptions of the same features will not be given below. The fifth embodiment is the same as the first embodiment except in the operation for controlling the conveyance of the developer t by the developing device when the developer amount detecting sensors 5a and 5b have detected that the amounts of developer t are less than predetermined amounts at substantially the same time. Therefore, the operation for conveying the developer t in the above-described case in the fifth embodiment will only be described.

In the fifth embodiment, when the developer amount detecting sensors 5a and 5b have detected that the amounts of developer t in the respective first container 2a and the second container 2b are less than the predetermined amounts at substantially the same time, the direction of rotation of the magnet roller 7, serving as a developer conveying member, is consecutively varied in order to alternately convey the developer t to the first container 2a and the second container 2b. Here, since the time for conveying the developer t to the first container 2a is made longer than the time for conveying the developer t to the second container 2b, the developer t is conveyed to the first container 2a first.

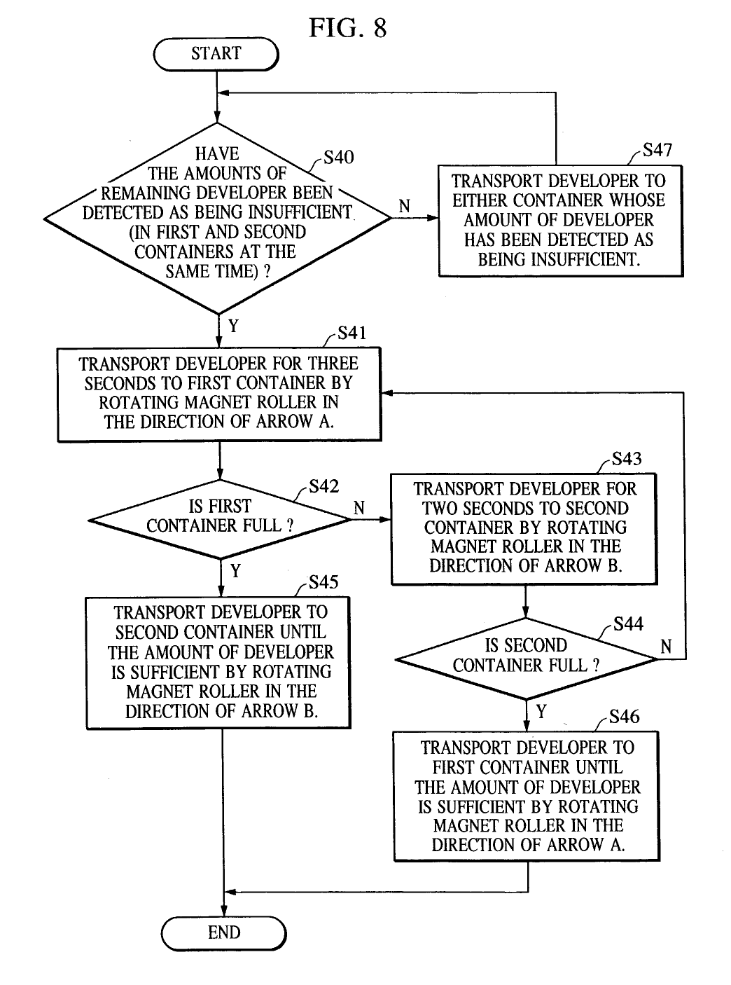

Hereunder, the steps for controlling the conveyance of the developer t when the developer amount detecting sensors 5a and 5b have detected that the amounts of developer t are less than the predetermined amounts at substantially the same time will be described with reference to the flow chart of FIG. 8.

In the case where, for example, a developing operation consuming a large amount of developer t is carried out, when the developer amount detecting sensors 5a and 5b detect that the amounts of developer t in the respective first and second containers 2a and 2b are less than the predetermined amounts at substantially the same time in Step S40, the magnet roller 7 is rotated in the direction of arrow A by a controlling operation of the controller 21 in order to convey the developer t to the first container 2a not containing enough developer t for three seconds in Step S41.

When the developer amount detecting sensor 5a has detected that the first container 2a is not sufficiently filled with the developer t (that is, the amount of developer t is less than the predetermined amount) in Step S42 after conveying the developer t for three seconds in Step S41, the magnet roller 7 is rotated this time in the direction of arrow B by the controlling operation of the controller 21 in order to convey the developer t to the second container 2b not containing enough developer t for two seconds in Step S43.

Then, when the developer amount detecting sensor 5b has detected that the second container 2b is not sufficiently filled with the developer t (that is, the amount of developer t is less than the predetermined amount) in Step S44 after conveying the developer t for two seconds in Step S43, the magnet roller 7 is rotated this time in the direction of arrow A by the controlling operation of the controller 21 in order to convey the developer t to the first container 2a not having enough developer t for three seconds in Step S41. In this way, the ratio between the time for conveying the developer t to the first container 2a and the time for conveying the developer t to the second container 2b by the rotation of the magnet roller 7 in alternate directions is three to two, so that a larger amount of developer t is conveyed to the first container 2a than to the second container 2b.

While the sequence of steps from Steps S41 to S44 is being repeated, when the developer amount detecting sensor 5a detects that the first container 2a has been sufficiently filled with the developer t (that is, the amount of developer t is greater than the predetermined amount) in Step S42, the magnet roller 7 is rotated this time in the direction of arrow B by the controlling operation of the controller 21 in order to convey the developer t to the second container 2b not containing enough developer t until it is sufficiently filled with the developer t in Step S45.

While the sequence of steps from Steps S41 to S44 is being repeated, when the developer amount detecting sensor 5b detects that the second container 2b has been sufficiently filled with the developer t (that is, the amount of developer t is greater than the predetermined amount) in Step S44, the magnet roller 7 is rotated this time in the direction of arrow A by the controlling operation of the controller 21 in order to convey the developer t to the first container 2a not containing enough developer t until it is sufficiently filled with the developer t in Step S46.

When the amount of developer t inside either the first container 2a or the second container 2b is detected as being less than the predetermined amount in Step S40, as in the first embodiment, the direction of rotation of the magnet roller 7 is selected by the controlling operation of the controller 21 in order to convey the developer t to either the first container 2a or the second container 2b not containing enough developer t until the amount of developer t inside the container not containing enough developer t is sufficient in Step S47.

Accordingly, in the embodiment, in the case where, for example, a developing operation consuming a large amount of developer t is carried out, when the developer amount detecting sensors 5a and 5b detect that the amount of developer t in the respective first container 2a and the second container 2b are less than the predetermined amounts at substantially the same time, the ratio between the time for conveying the developer t to the first container 2a and the time for conveying the developer t to the second container 2b by the rotation of the magnet roller 7 in alternate directions is three to two. By conveying a larger amount of developer t to the first container 2a than to the second container 2b, the shortage of the developer t on the developing roller 3a which greatly affects the image density is reduced, thereby preventing an image from being formed with improper density. Therefore, a sharp, high-quality image can be obtained.

Although, in this embodiment, although the developer t is conveyed to the first container 2a for three seconds and the developer t is conveyed to the second container 2b for two seconds, the developers t may be conveyed for any lengths of time as long as the times for conveying the developers t are adjusted so that a larger amount of developer t is conveyed to the first container 2a than to the second container 2b.

(Sixth Embodiment)

A sixth embodiment of the developing device will be described using the image forming apparatus including the developing device of the third embodiment shown in FIG. 5. The image forming apparatus including the developing device of the sixth embodiment has a structure similar to that of the image forming apparatus including the developing device of the third embodiment. Therefore, descriptions of the same features will not be given below. The sixth embodiment is the same as the third embodiment except in the operation for controlling the conveyance of the developer t by the developing device when at least two of the developer amount detecting sensors 5a, 5b, and 5c have detected that the amounts of developer t are less than predetermined amounts at substantially the same time. Therefore, the operation for conveying the developer t in the above-described case in the sixth embodiment will only be described.

When, for example, a developing operation consuming a large amount of developer t is carried out, in particular, the developer amount detecting sensors 5b and 5c may detect that the amounts of developer t in the respective second container 2b and the third container 2c are less than the predetermined amounts at substantially the same time. In this case, the developer t cannot be conveyed to the second container 2b and the third container 2c at the same time because the magnet roller 7a is formed to selectively convey (supply) the developer t to either the second container 2b or the third container 2c in the direction of rotation of the magnet roller 7a.

Therefore, when the developer amount detecting sensors 5a and 5b detect that the amounts of developer t are less than the predetermined amounts at substantially the same time, it is necessary to select either the second container 2b or the third container 2c as the container to which the developer t is to be conveyed/supplied first. As described above, the developing roller 3b that is positioned at the upstream side in the direction of movement (rotation) of the photosensitive drum 9 more greatly affects the image density, so that, when the upstream-side developing roller 3b does not have enough developer t applied thereto, the desired image quality may not be obtained.

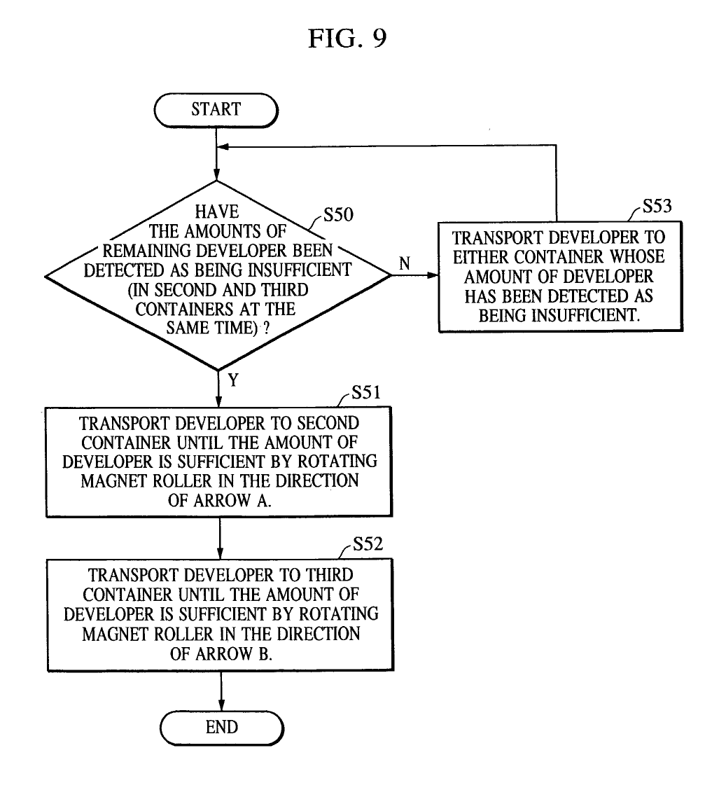

Considering what has been discussed above, the steps for controlling the conveyance of the developer t when the developer amount detecting sensors 5b and 5c have detected that the amounts of developer t are less than the predetermined amounts at substantially the same time will be described with reference to the flowchart of FIG. 9.

First, in the case where, for example, a developing operation consuming a large amount of developer t is carried out, when the developer amount detecting sensors 5b and 5c detect that the amounts of developer t in the respective second and third containers 2b and 2c are less than the predetermined amounts at substantially the same time in Step S50, the magnet roller 7a is rotated in the direction of arrow A by a controlling operation of the controller 21 in order to convey the developer t to the second container 2b not containing enough developer t until the amount of developer t inside the second container 2b is sufficient in Step S51.

Then, when a sufficient amount of developer t has been conveyed to the second container 2b and the developer amount detecting sensor 5b detects that the amount of developer t inside the second container 2b is greater than the predetermined amount, the magnet roller 7a is rotated this time in the direction of arrow B by the controlling operation of the controller 21 in order to convey the developer t to the third container 2c not containing enough developer t until the amount of developer t inside the third container 2c is sufficient in Step S52.

When the amount of developer t inside either the second container 2b or the third container 2c is detected as being less than the predetermined amount in Step S50, the direction of rotation of the magnet roller 7a is selected by the controlling operation of the controller 21 in order to convey the developer t to either the second container 2b or the third container 2c not containing enough developer t until the amount of developer t inside the container not containing enough developer t is sufficient in Step S53.

When the developer amount detecting sensors 5b and 5c have detected that the amounts of developer t inside the respective second container 2b and the third container 2c are less than the predetermined amounts, first, the magnet roller 7a is rotated in the direction of arrow A in order to convey the developer t into the second container 2b. Then, it is rotated in the direction of arrow B in order to convey the developer t into the third container 2c. Therefore, the shortage of the developer t on the developing roller 3b that greatly affects the image density is reduced, thereby preventing an image from being formed with improper density. Consequently, a high-quality image can be obtained.

In the sixth embodiment, when the developer amount detecting sensors have detected at the same time that the amounts of developer in the respective first container, the second container, and the third container are less than the predetermined amounts, the conveyance of the developer to the first container is controlled in accordance with a signal from the developer amount detecting sensor at the first container regardless of the amounts of developer inside the second and third containers.

The developer is conveyed to the second and third containers so that the developer is conveyed first to the container disposed at the upstream side in the direction of movement or rotation of the photosensitive drum (the second container in the sixth embodiment).

Although, in the sixth embodiment, the developer is independently conveyed to the first container, and single conveying means is used to convey ink to the second and third containers, any arrangement may be used in actually conveying the ink.

In the case where, for example, a developing operation consuming a large amount of developer is carried out, when detections are made that the amounts of developer t in at least two of the first, second, and third containers 2a, 2b, and 2c are not sufficient at the substantially the same time, the developer t is first conveyed to the container not containing enough developer t disposed at the upstream side in the direction of movement (rotation) of the photosensitive drum 9. Therefore, the shortage of the developer t on the developing rollers 3a and 2a that greatly affect the density image is reduced, thereby preventing an image from being formed with improper density. Consequently, a high-quality image can be obtained.

As can be understood from the foregoing description, according to the embodiments, it possible to reduce the size of the developing device as well as to stably supply a developer to the first developer container and to the second developer container. Therefore, it is possible to reduce the size of the developer as well as to stably obtain a high-quality image by preventing improper developing operation caused by an insufficient amount of developer.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A developing device comprising:
a first developer container containing a developer;
a first developer bearing member for bearing and conveying the developer inside the first developer container;
a second developer container containing a developer;
a second developer bearing member for bearing and conveying the developer inside the second developer container;
wherein an electrostatic image on an image bearing member is developed by supplying the developer from the first developer bearing member and the second developer bearing member to the electrostatic image; and
single developer conveying means for selectively conveying a supply developer inside a developer supplying container to either the first developer container or the second developer container.

2. A developing device according to claim 1, wherein the first developer container and the second developer container have a first developer receiving opening and a second developer receiving opening, respectively, for receiving the supply developer from the developer supplying container, and wherein the developer conveying means comprises a single rotary member, disposed at the first and second developer receiving openings, for conveying the supply developer.

3. A developing device according to claim 2, wherein by switching the direction of rotation of the rotary member, the developer is selectively conveyed to either the first developer container or the second developer container.

4. A developing device according to claim 3, wherein the first developer receiving opening and the second developer receiving opening are disposed in the upper portion of the first developer container and the upper portion of the second developer container, respectively.

5. A developing device according to claim 4, wherein the developer is a magnetic developer, and wherein the rotary member magnetically bears and conveys the supply developer.

6. A developing device according to claim 1, wherein a common electrostatic image on the image bearing member is developed by supplying the developer from the first developer bearing member and the second developer bearing member in that order.

7. A developing device according to any one of claims 1 to 6 further comprising detecting means for detecting amounts of the developer inside the first and second developer containers, and selecting means for selecting the developer container to which the supply developer is to be conveyed first by the developer conveying means based on an output from the detecting means.

8. A developing device according to claim 7, wherein, when a determination is made that the first developer container and the second developer container do not have enough developer based on the output from the detecting means, the selecting means selects the second developer container as the developer container to which the supply developer is to be conveyed first by the developer conveying means.

9. A developing device according to claim 7, wherein, when a determination is made that the first developer container and the second developer container do not have enough developer based on the output from the detecting means, the selecting means selects the first developer container as the developer container to which the supply developer is to be conveyed first by the developer conveying means.

10. A developing device according to claim 1, wherein the first and second developer containers are integrally formed.
